(19) United States
(12) Patent Application Publication
(10) Pub. No.: US 2007/0027793 A1
(43) Pub. Date: Feb. 1, 2007

(54) Systems and methods for maintaining the viability of a market order type in fluctuating markets

(76) Inventors: Howard W. Lutnick, New York, NY (US); Michael Sweeting, Aldershot (GB); Joseph Noviello, New York, NY (US)

Correspondence Address: FISH & NEAVE IP GROUP;ROPES &GRAY LLP, 1251 AVENUE OF THE AMERICAS FL C3, NEW YORK, NY, 10020-1105, US

(21) Appl. No.: 11/195,155

(22) Filed: Aug. 1, 2005

(51) Int. Cl. G06Q 40/00

(52) U.S. Cl. 705/37

(57) ABSTRACT

Systems and methods for maintaining the viability of a market order type in fluctuating markets are provided. These systems and methods preferably provide the user with the ability to enter an order as a “conditional” market order. Such an order will preferably only be implemented as a market order under certain specific circumstances—e.g., the market has met a predetermined stability threshold for a preferably predetermined amount of time.

### BACKGROUND OF THE INVENTION

The present invention relates to electronic trading systems and methods. Specifically, this invention relates to a set of rules that governs the implementation of market orders in electronic trading systems.

Many electronic trading systems provide the ability for participants to enter market orders into the respective systems.

A market order is an order to buy or sell a stock at the current market price. Unless a participant specifies otherwise, the broker typically enters a participant's order to buy or sell a quantity of an item as a market order.

The advantage of a market order is that the participant is almost always guaranteed that the order will be executed (as long as there are willing buyers and sellers). Depending on a broker's commission structure, a market order may also be less expensive than a limit order.

One disadvantage of a market order is the price paid when the order is executed may not always be the price obtained from a real-time quote service or the price quoted by the broker. This may be especially true in fast-moving markets where stock prices are more volatile. Also, when a participant places an order “at the market,” particularly for a large number of shares, there is a greater chance the participant will receive different prices for parts of the order.

It would be desirable to reduce the uncertainty associated with market orders while maintaining the viability of market orders in the marketplace.

### SUMMARY OF THE INVENTION

It is an object of the invention to reduce the uncertainty associated with market orders while maintaining the viability of market orders in the marketplace.

A method for trading an item in an electronic market supported by an electronic trading system is provided. The method includes receiving an incoming market order and determining whether the electronic market satisfies a set of predetermined criteria. If the market satisfies the set of predetermined criteria, then the method preferably presents the incoming market order to the electronic market as a market order.

If the electronic market does not satisfy the set of predetermined criteria, then the method preferably includes modifying the incoming market order to change it to a passive order presenting the incoming market order to the electronic market at a predetermined price increment from the best order that is contra to the incoming market order. Alternatively, the incoming order may be modified as some other suitable non-market order type.

### BRIEF DESCRIPTION OF THE DRAWINGS

Further features of the invention, its nature and various advantages will be apparent from the following detailed description of the preferred embodiments, taken in conjunction with the accompanying drawings, in which like reference characters refer to like parts throughout, and in which:

FIG. 1 is an illustration of an electronic implementation of a system in accordance with some embodiments of the present invention;

FIG. 2 is an illustration, in greater detail, of an electronic implementation of a system in accordance with some embodiments of the present invention; and

FIGS. 3-6 are flowcharts of various methods according to the invention.

### DESCRIPTION OF THE INVENTION

Trading systems that use a conventional market order type allow participants to submit a bid or an offer and know that the bid or the offer will, in typical circumstances, result in a trade. In accordance with the invention, a trading system may be given a system setting to only submit market orders at the current market price if the market price has achieved a preferably predetermined threshold level of stability or some other suitable criteria. This level of stability can be characterized in one of a number of ways according to the invention as is described in more detail below.

Otherwise, if the market associated with the market order according to the invention has failed to achieve the threshold level of stability at the time of the submission of the market order, the market order may preferably be placed in the market as a passive or resting order a certain amount [X] of price increments—e.g., ticks—away from the current best market price. For example, if a participant enters a buy @ market order, with a non-stable specification of 2 increments, this instructs the system that, if the electronic market is not stable then bid 2 increments away from the current offer price.

In this example, the initial system setting of X may be two price increments for US Treasuries. An exemplary increment in US Treasuries is that two-year Treasury Notes trade at a standard minimum price increment of ¼ of 1/32 of one percent of the nominal value of the Treasury Note. The value of X may be set either by the trading system for a particular participant, or by the particular participant, and the trading system may be configured for either value to prevail.

With such a novel order type, participants can have the ability to preferably limit the uncertainty associated with typical market orders. This uncertainty is reduced because their respective market orders are only submitted as market orders when the market meets preferably predetermined stability criteria. Otherwise, the orders are submitted as resting orders.

Thresholds of market stability or other suitable criteria may be defined in the following ways or in any other suitable fashion. In one embodiment according to the invention, to achieve the threshold of stability, the current market price should preferably be unchanged for a certain, preferably predetermined, amount of time. This amount of time may be set either by the trading system for a particular participant, or by the participant or for all participants, and the trading system may be configured for either value to prevail.

Alternatively, the threshold of stability may require that the market price is within a predetermined range for a period of time. According to this embodiment, relatively minor changes in the market preferably do not affect whether a market order is modified to be submitted as a resting order.

In yet another alternative embodiment, the threshold of stability may be based on a level of volume associated with the market for the item. For example, if the daily volume for the item was above a certain amount relative to, or within a particular range relative to, for example, the average volume at the same time of day as derived from trading over the last three months, then the threshold is achieved. Alternatively, the threshold may be characterized in terms of being within a particular range of volume traded above and below an average volume or other suitable volume measurement.

In still another alternative embodiment of the invention, the threshold of stability could be dependent on factors other than price and volume. One such factor may be time of day. For example if the market order according to the invention was submitted in the first hour of trading, when the price can be less reliable, then the market order may be modified to be submitted as a resting order as described above. Such a modification may preferably be a system-defined modification or a user-configured modification.

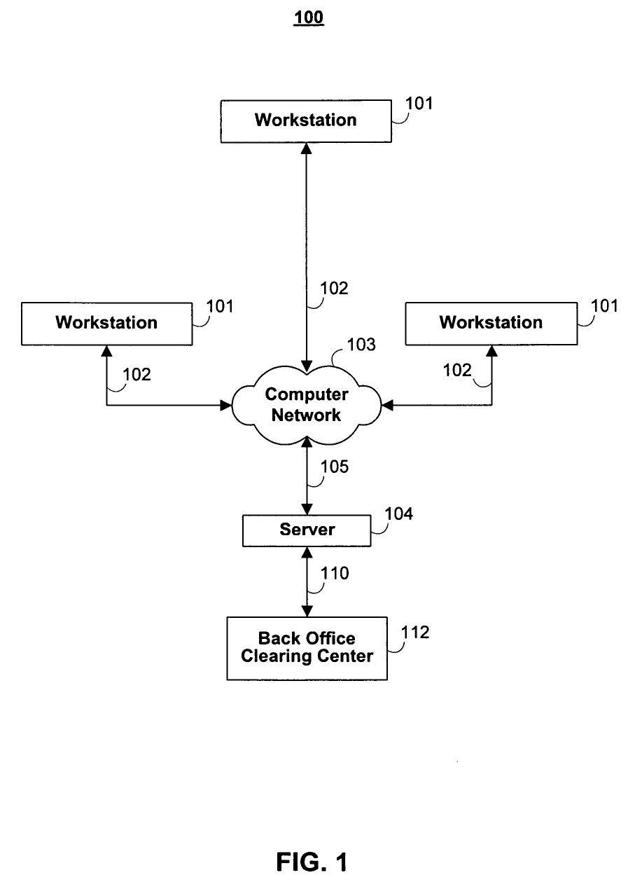

Referring to FIG. 1, exemplary system 100 for implementing the present invention is shown. As illustrated, system 100 may include one or more workstations 101. Workstations 101 may be local or remote, and are connected by one or more communications links 102 to computer network 103 that is linked via communications links 105 to server 104. Server 104 is linked via communications link 110 to back office clearing center 112.

In system 100, server 104 may be any suitable server, processor, computer, or data processing device, or combination of the same. Server 104 and back office clearing center 112 may form part of the electronic trading system. Furthermore, server 104 may also contain an electronic trading system and application programming interface and merely transmit a Graphical User Interface or other display screens to the user at the user workstation, or the Graphical User Interface may reside on Workstation 101.

Computer network 103 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 102 and 105 may be any communications links suitable for communicating data between workstations 101 and server 104, such as network links, dial-up links, wireless links, hard-wired links, etc.

Workstations 101 may be personal computers, laptop computers, mainframe computers, dumb terminals, data displays, Internet browsers, Personal Digital Assistants (PDAs), two-way pagers, wireless terminals, portable telephones, programmed computers having memory, the programmed computer using the memory for implementing trading models, etc., or any combination of the same. Workstations 102 may be used to implement the electronic trading system application and application programming interface according to the invention.

Back office clearing center 112 may be any suitable equipment, such as a computer, a laptop computer, a mainframe computer, etc., or any combination of the same, for causing transactions to be cleared and/or verifying that transactions are cleared. Communications link 110 may be any communications links suitable for communicating data between server 104 and back office clearing center 112, such as network links, dial-up links, wireless links, hard-wired links, etc.

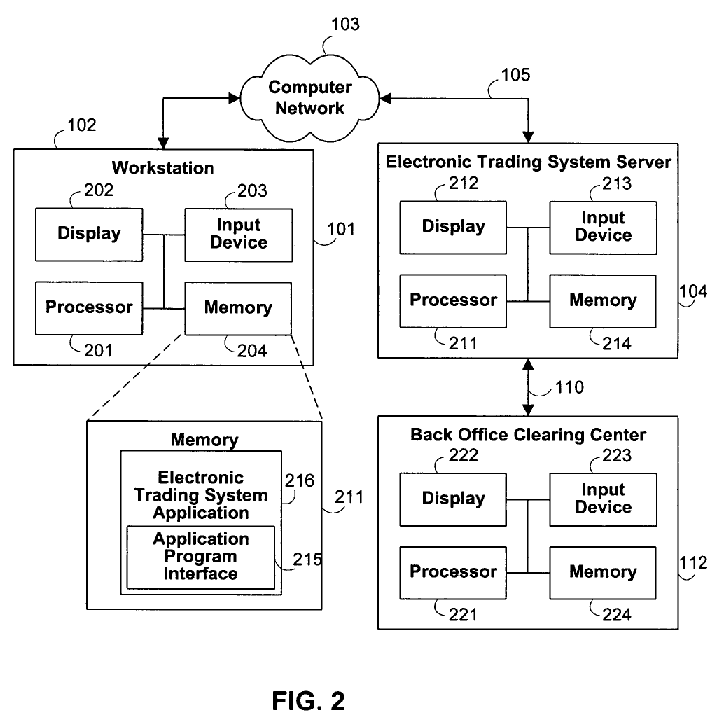

The server, the back office clearing center, and one of the workstations, which are depicted in FIG. 1, are illustrated in more detail in FIG. 2. Referring to FIG. 2, workstation 101 may include processor 201, display 202, input device 203, and memory 204, which may be interconnected. In a preferred embodiment, memory 204 contains a storage device for storing a workstation program for controlling processor 201. The storage device may include software stored on a suitable storage medium such as a disk. Memory 204 also preferably contains an electronic trading system application 216 according to the invention.

Electronic trading system application 216 may preferably include application program interface 215, or alternatively, as described above, electronic trading system application 216 may be resident in the memory of server 104. In this embodiment, the electronic trading system may contain application program interface 215 as a discrete application from the electronic trading system application which also may be included therein. The only distribution to the user may then be a Graphical User Interface which allows the user to interact with electronic trading system application 216 resident at server 104.

Processor 201 uses the workstation program to present on display 202 electronic trading system application information relating to market conditions received through communication link 102 and trading commands and values transmitted by a user of workstation 101. Furthermore, input device 203 may be used to manually enter commands and values in order for these commands and values to be communicated to the electronic trading system.

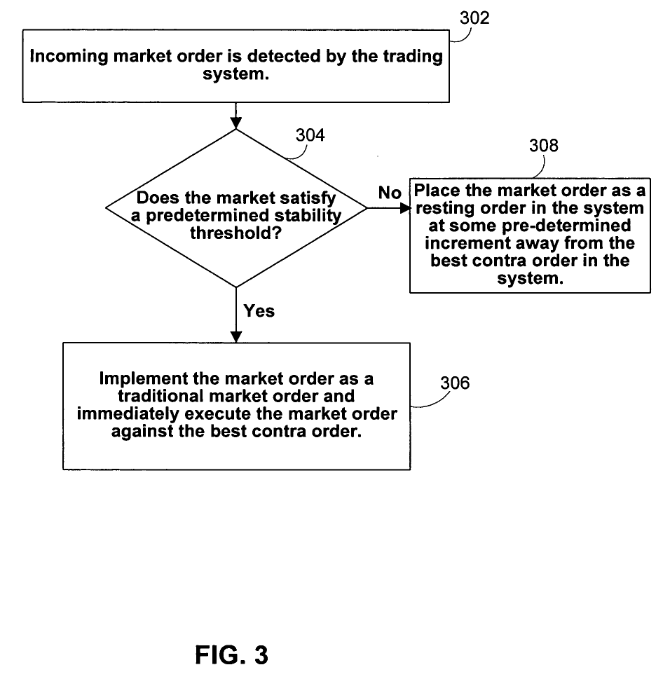

FIG. 3 is a flow chart that illustrates one embodiment of a method according to the invention. Step 302 shows that an incoming market order is detected by the trading system. Step 304 queries whether the market satisfies a preferably predetermined stability threshold. It should be noted that this threshold may be either a system-set threshold or a user-configured threshold. Step 306 shows that, if the current market satisfies the stability threshold, then the market order is implemented as a traditional market order and is preferably immediately executed against the best contra order. If the market does not satisfy the market stability threshold, then the market order is placed in the system as a resting order at some pre-determined increment away from the best contra order in the system (or, alternatively, at some pre-determined increment away from the best order on the same side of the market).

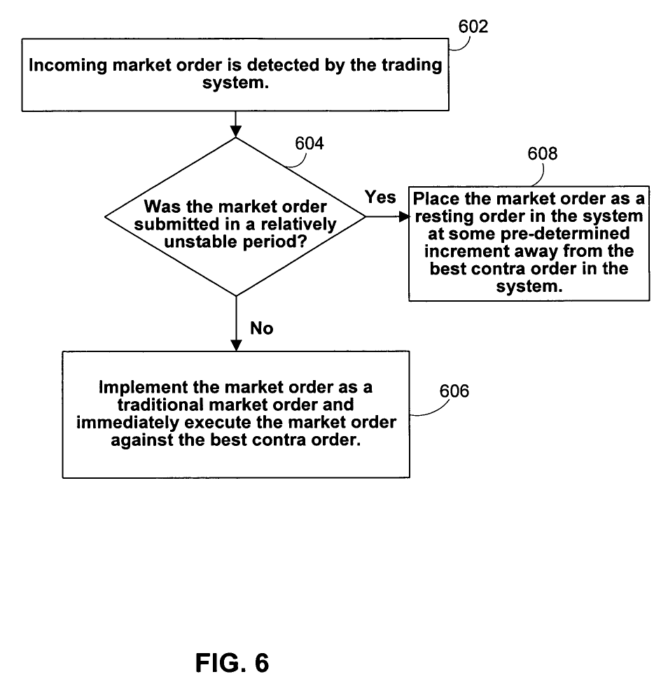

It should be noted that each of FIGS. 3-6 share similar steps X02, X06, and X08, except as detailed with respect to FIG. 6 below. The FIGs. are differentiated, for the most part, based on the query step of X04 in which each flow chart describes a unique query.

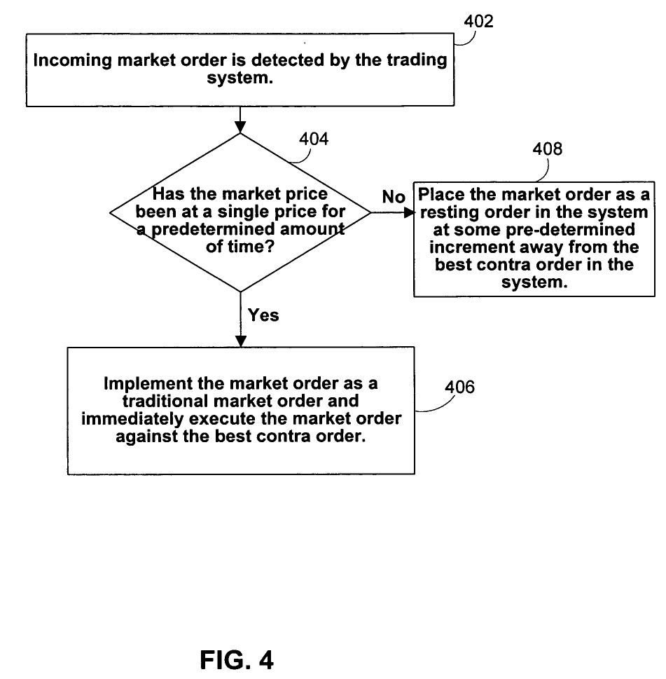

FIG. 4 is flow chart describing another embodiment of a method according to the invention. Query step 404 queries whether the market has been at a single price for a preferably predetermined amount of time. If the market has been at a single price for a preferably predetermined amount of time, under certain circumstances, the market order according to the invention may preferably be implemented as a traditional market order.

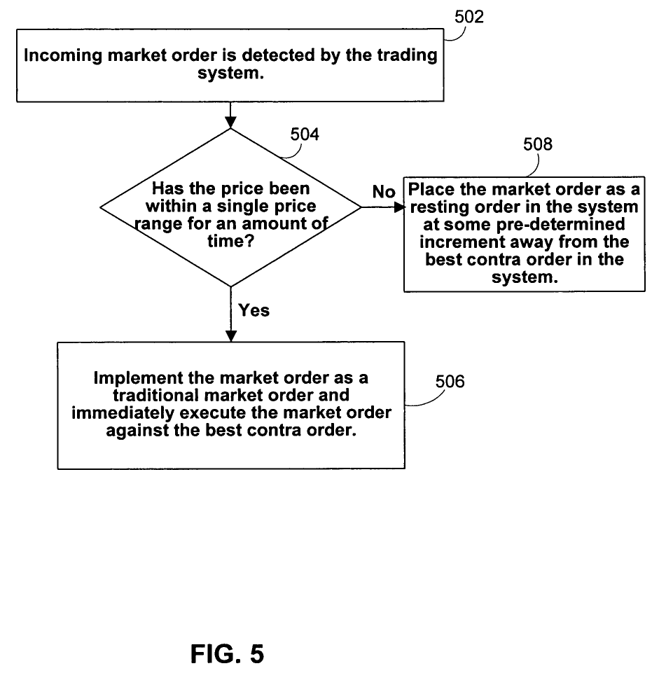

FIG. 5 is a flow chart describing yet another embodiment of a method according to the invention. Query step 504 queries whether the market price has been within a single price range for an amount of time. If the market price has been within a single price range for an amount of time, then the market order according to the invention is implemented as a traditional market order and the system preferably immediately executes the market order against the best contra order.

FIG. 6 is a flow chart describing still another embodiment of a method according to the invention. Step 604 queries whether the market order according to the invention was submitted in the first hour of trading (or some other relatively less reliable time of day). If the incoming order was submitted in the first hour of the day, then the incoming market order may preferably be automatically implemented as a resting order. It should be noted that in FIG. 6, a “no” answer to the query generates a traditional market order implementation and a “yes” answer generates a modified order implementation according to the invention.

Thus, systems and method for defining criteria for maintaining the viability of a market order type in fluctuating markets have been provided. It will be understood that the foregoing is only illustrative of the principles of the invention, and that various modifications can be made by those skilled in the art without departing from the scope and spirit of the invention.

What is claimed is:

1. A method for trading an item in an electronic market supported by an electronic trading system, the method comprising:
receiving an incoming market order;
determining whether the electronic market satisfies a set of predetermined criteria;
if the market satisfies the set of predetermined criteria, presenting the incoming market order to the electronic market as a market order.

2. The method for trading an item according to claim 1 further comprising, if the market does not satisfy the set of predetermined criteria, presenting the incoming market order to the electronic market at a predetermined price increment from the best order that is contra to the incoming market order.

3. The method for trading an item according to claim 1 wherein the determining comprises determining whether at least one of the best bid price and the best offer price in the electronic market satisfies a predetermined stability threshold.

4. The method for trading an item according to claim 1 wherein the determining comprises determining whether the electronic market satisfies a volume threshold.

5. The method for trading an item according to claim 1 wherein the determining comprises determining whether the incoming market order was entered during a predetermined time.

6. The method for trading an item according to claim 1 wherein the determining comprises determining using a set of predetermined criteria that is at least one of user-configurable and system-defined.

7. A system for trading an item in an electronic market supported by an electronic trading system, the system comprising:
an order receiving component for:
receiving an incoming market order;
determining whether the electronic market satisfies a set of predetermined criteria;
if the market satisfies the set of predetermined criteria, presenting the incoming market order to the electronic market as a market order.

8. The system for trading an item according to claim 7 further comprising the order receiving component for, if the market does not satisfy the set of predetermined criteria, presenting the incoming market order to the electronic market at a predetermined price increment from the best order that is contra to the incoming market order.

9. The method for trading an item according to claim 7 wherein the determining comprises determining whether at least one of the best bid price and the best offer price in the electronic market satisfies a predetermined stability threshold.

10. The system for trading an item according to claim 7 wherein the determining comprises determining whether the electronic market satisfies a volume threshold.

11. The system for trading an item according to claim 1 wherein the determining comprises determining whether the incoming market order was entered during a predetermined time.

12. The system for trading an item according to claim 1 wherein the determining comprises determining using a set of predetermined criteria that is at least one of user-configurable and system-defined.

13. A computer readable medium for trading an item in an electronic market supported by an electronic trading system, the computer readable medium comprising:
a first program code for receiving an incoming market order;
a second program code for determining whether the electronic market satisfies a set of predetermined criteria;
a third program code for presenting the incoming market order to the electronic market as a market order if the market satisfies the set of predetermined criteria.

14. The computer readable medium for trading an item according to claim 13 further comprising a fourth program code for presenting the incoming market order to the electronic market at a predetermined price increment from the best order that is contra to the incoming market order if the market does not satisfy the set of predetermined criteria.

15. The computer readable medium for trading an item according to claim 13 wherein the determining comprises determining whether at least one of the best bid price and the best offer price in the electronic market satisfies a predetermined stability threshold.

16. The computer readable medium for trading an item according to claim 13 wherein the determining comprises determining whether the electronic market satisfies a volume threshold.

17. The computer readable medium for trading an item according to claim 13 wherein the determining comprises determining whether the incoming market order was entered during a predetermined time.

18. The computer readable medium for trading an item according to claim 13 wherein the determining comprises determining using a set of predetermined criteria that is at least one of user-configurable and system-defined.
